(19) United States
(12) Patent Application Publication
(10) Pub. No.: US 2014/0200142 A1
(43) Pub. Date: Jul. 17, 2014

(54) TREATMENT OF STORED TUBERS WITH AEROSOLS OF HIGHER ALCOHOLS

(71) Applicant: 1,4 Group, Inc., Meridian, ID (US)

(72) Inventors: John M. Forsythe, Nampa, ID (US); James Zalewski, Boise, ID (US); Curtis Lee Eames, Meridian, ID (US); Henry John Duncan, Glasgow (GB)

(73) Assignee: 1,4 Group, Inc., Meridian, ID (US)

(21) Appl. No.: 14/152,950

(22) Filed: Jan. 10, 2014

Related U.S. Application Data
(60) Provisional application No. 61/753,304, filed on Jan. 16, 2013.

(51) Int. Cl. A01N 31/02

(52) U.S. Cl. CPC A01N 31/02
USPC 504/162

(57) ABSTRACT

A method and composition of treating post-harvest tubers with a higher alcohol as a thermofogged aerosol to suppress sprouting is disclosed.

### CROSS-REFERENCE TO RELATED APPLICATION

This application claims the benefit of U.S. Provisional Patent Application Ser. No. 61/753,304, filed Jan. 16, 2013, the disclosure of which is hereby incorporated herein in its entirety by this reference.

### TECHNICAL FIELD

This invention relates generally to chemical compositions and processes useful to treat crops, especially tubers, during post-harvest, in storage, and/or in transit to consumers or to processing facilities.

### BACKGROUND OF INVENTION

Many crops, e.g., potatoes, and other tubers and bulbs such as onions, in particular, are stored for an extended period after harvest. These crops are treated with pesticides, fungicides, and herbicides of a nature which prevent sprouting of the crop during storage as well as other deleterious events. This is especially true for tubers, such as potatoes.

The principal herbicide, CIPC (chlorpropham or chloro-isopropylcarbamate), has been used for decades as a sprout inhibitor for potatoes. It is very effective, but it is receiving increased scrutiny from the US EPA and UK/EU Chemical Safety Commissions, which have been limiting the dosages that may be applied. CIPC acts as a mitosis inhibitor in suppressing sprouting. It is applied as an aerosol generally before the stored potato pile has settled before dormancy has ended, i.e., typically before any sprouting has occurred.

U.S. Pat. Nos. 5,935,660 and 6,068,888 to Forsythe et al. describe a current technique for thermofogging solid CIPC to provide an effective, stable aerosol.

More recently, 1,4 dimethyl naphthalene has been used effectively as a dormancy enhancer/sprout inhibitor for potatoes. Its action is hormonal in nature. This chemical also helps the potatoes stay turgid (hydrated). It is available from 1,4 Group, Meridian, Id. as 1,4 SIGHT®. Numerous patents have been issued relative to the use of 1,4-DMN, such as U.S. Pat. No. 5,918,537, U.S. Pat. No. 5,965,489, U.S. Pat. No. 6,010,728, U.S. Pat. No. 6,310,004, U.S. Pat. No. 6,375,999, and U.S. Pat. No. 6,403,536.

Stored tubers, such as potatoes, tend to sprout during storage. Distributors and grocers providing fresh-pack potatoes to consumers, desire such potatoes to show no evidence of peeps or sprouts. Various techniques such as the use of clove oil or CIPC late in the storage season or during processing of potatoes in packing sheds have been used to “burn” any peeps or sprouts present. However, clove oil has an objectionable odor while CIPC is not desirable on potatoes to be consumed without being washed or processed into products, such as French fries.

A principal drawback to 1,4-DMN is its cost and the fact that it is volatile and tends to diffuse from treated potatoes over a length of time. It has been used commercially in accordance with the above listed patents.

Stored potatoes were treated continuously by Burton with vapors of a nonanol isomer (3,5,5-trimethyl hexanol), with generally unsatisfactory results. Burton employed a “wicking” technique to provide continuous vapors over an extended period. While this alcohol strongly “burned” (desiccated) existing sprouts, it damaged potato flesh, especially near affected eyes. Alcohols, in general, are regarded as strong desiccating agents, which is their mode of impairing existing potato sprouts.

Lower alcohols, such as methanol, isopropanol and the like, are good solvents for CIPC and could, perhaps, contribute to sprout inhibition. However, CIPC solutions, when applied to stored potatoes as an aerosol, via thermofoggers, are subjected to very high temperatures, e.g., 700° F. and above, which temperatures tend to decompose lower molecular weight alcohols, especially methanol, creating toxic decomposition products. Methanol itself is toxic and its decomposition products, such as formaldehyde, are toxic and are not useful sprout inhibitors and are generally considered undesirable as residue on potatoes.

Higher alcohols, such as C₆-C₁₂ alcohols, are less volatile than lower molecular weight alcohols. However, the flesh damaging characteristics of these alcohols reported in prior literature have generally precluded their adoption as commercial sprout inhibitors for potatoes.

During the 1950's, especially in the U.K., considerable experimentation, and even commercial treatment occurred with higher alcohols, especially alkyl alcohol and nonanol. In Nature, vol. 178, p. 218 (Jul. 28, 1956) Burton tested alcohols of C₁ to C₁₀ carbon chain length. Best results were achieved with amyl and nonyl alcohols. Worst results were for n-hexyl and 2-ethyl-hexan-1-01, an octyl alcohol. Later, in his book “The Potato” (1966), Burton summarizes work with nonanol (3,5,5-trimethyl-hexan-1-01) vapor at pages 285 and 286. There he comments that high initial concentrations would be toxic to the tubers. His treatments were for equal periods of two weeks on and two weeks off until the potatoes are removed from store. He states a consumption of nonanol of about 300 g per 1000 kg (300 ppm) potatoes for every month of storage. He further notes that the killed sprouts may die back into the tuber flesh, with resultant blemishes and possibly rotting if sprouting has become well advanced before application of nonanol.

Even higher molecular weight aldehydes and ketones, such as certain ∝, β-unsaturated alphatic compounds identified by Knowles et al. (U.S. Pat. No. 6,855,669) show pitting of the potato. In this regard see Example 4, col. 11, lines 50 et seq. of the Knowles patent. It may further be noted that preferred compounds advanced by Knowles et al. are effective as sprout inhibitors only at very high dosages, e.g., in excess of 70 ppm and that numerous treatments per storage season would be required to maintain stored potatoes in a sprout free condition. The preferred aldehydes identified by Knowles et al. have a chemical structure nearly identical with citral, a known sprout inhibitor, which is known to be effective only at high dosages. A similar preference for alkenyl compounds is described in U.S. Pat. No. 3,159,476 wherein an octenyl alcohol mixture is shown to be superior to an isooctyl alcohol as a sprout inhibitor for potatoes. This 1964 patent is in the same timeframe as Burton's work when various types of alcohols were being tested and then later abandoned for commercial purposes for a wide variety of reasons. No notation is made in the U.S. Pat. No. 3,159,476 patent as to whether there was pitting of the potatoes. Also, it is not stated whether the potatoes were in a dormant state when the treatments were commenced. The 25° C. storage temperature (˜78° F.) is not a commercial storage temperature for potatoes (Ex. I-III) nor is 15° C. (˜59° F.) in Ex. IV-VI.

### SUMMARY OF THE INVENTION

A particular embodiment is drawn to a method of desiccating sprouts existing on post harvest potatoes including: thermofogging an alcohol selected from the group consisting of heptanol, octanol, nonanol, and decanol to create a stable aerosol of said alcohol; and introducing said aerosol into a mass of potatoes containing potatoes exhibiting sprouts for a predetermined period of time at a predetermined dosage to desiccate effectively such sprouts.

Another embodiment is drawn to a method of desiccating sprouts on post-harvest potatoes that include applying a thermofogged aerosol of a C₈-C₁₀ alkyl alcohol for a predetermined period of time to provide a concentration of said alcohol in the atmosphere surrounding said potatoes effective to desiccate sprouts and/or peeps present upon said potatoes.

### BRIEF DESCRIPTION OF THE DRAWING

FIG. 1 is a graph that illustrates the effectiveness of higher saturated alkyl alcohols.

### DETAILED DESCRIPTION

It has been discovered that higher alcohols having C₅-C₁₂ alkyl and alkenyl carbon chains, whether linear chains or branched chains, can be effectively applied as a sprout suppressant via thermoaerosol generation without adverse results, such as pitting in or near potato eyes. The technique generally employs the alcohols at a low dosage per unit weight of potatoes being treated. Also, the aerosols are preferably applied to potatoes after “peeps” (nascent sprouts) or sprouts have developed. Depending upon other factors, this may be an advantage to a grower, who can defer treatment until after peeps or sprouts occur, thereby minimizing or eliminating all together, the cost of other sprout control treatments, depending upon the inherent dormancy period of that batch of potatoes and the timing of their sale or use.

One experimental technique for thermofogging these higher alcohols at low dosages used a diluent such as water in admixture with a desired volatile alcohol such as 1-octanol, 1-nonanol, or 1-decanol. While higher alcohols and water are generally immiscible with one another, an agitated mixture employing water in the range of 1:1 to 3:1 volume in ratios of water to alcohol can be readily thermofogged at temperatures of about 400° F. to about 550° F. Higher fogging temperatures present the risk of combustion of the alcohol. Also, the presence of water vapor along with the alcohol vapor surrounding potatoes to be treated may moderate the desiccating effect of the alcohol to obtain good “burning” of peeps and sprouts without damage to the flesh of the treated potatoes. Given the high humidity, typically greater than 80% and often at 95%, present in commercial storages, the use of a diluent such as water may not be necessary to prevent damage to the body of a treated tuber.

A particular embodiment includes aerosolizing higher alcohols at appropriate temperatures and rates of application to control dosage and treatment time, whether such alcohols are thermofogged alone or as conjunction with other chemicals. Thermofogging of higher alcohols can be performed at temperatures not exceeding about 600° F., and preferably at temperatures below about 550° F., to produce a stable aerosol which is efficiently dispersed throughout a potato storage facility by its internal circulation system. This technique provided better control than the wicking system employed by Burton whereby a continuous vapor of alcohol was introduced into the headspace of a storage facility for time periods of up to two weeks.

Applying an aerosol of a higher alcohol for a short duration of a few hours at a predetermined concentration immediately desiccates (burns) existing sprouts so that the sprouts are blackened within 24 hours or less. Once this effect is achieved, further treatments are unnecessary until the sprouts regrow, which usually takes a month or more. Also, because the effect (sprout burn) is immediate, such treated potatoes may be immediately shipped for processing or to grocery stores for consumption or to processing facilities for making French fries, chips, etc. Because of the high volatility of the higher alcohols described herein, little residue is present when the potatoes are removed from storage and exposed to a normal atmosphere environment. Thus, such potatoes may be safely consumed, especially since preferred higher alcohols are on the GRAS (Generally Regarded as Safe) list. Care must be exercised during treatment of bulk storages at low temperatures to avoid any condensation of an applied higher alcohol upon potatoes stored at low temperatures. Direct contact of liquid alcohol has been shown to result in injury to potato flesh and eyes.

Many higher alcohols are included on the GRAS (Generally Regarded as Safe) list, making them especially useful for treatment of a food product. Thus, alcohols identified on the GRAS list may be applied alone or in conjunction with another chemical which is registered with the EPA on fresh-pack potatoes. Especially useful in this regard is 1-octanol, which is on the GRAS list and also on an exempt list as a food additive and has a mild, pleasant aroma.

### EXAMPLE I

Liquid 1-nonanol was fed to a thermofogger set to operate at an aerosolization temperature of about 550° F. The temperature quickly increased to about 750° F., indicating that the nonanol was combusting. A “fog-like” material emanated from the thermofogger nonanol.

### EXAMPLE II

Stored potatoes in a small open container were treated with 1-nonanol (n-nonyl alcohol) via a thermofogger to determine sprout destruction. The thermofogger was operated at an aerosol chamber temperature of about 500° F. A good stable aerosol was produced. The alcohol was applied at a dosage of 8 ml for 2 kg of potatoes. The system was open so that the actual dosage reaching the potatoes was considerably less than the fogged amount. The potatoes were exposed to the thermofog for approximately one minute, after which the treatment containers (1-gallon bottles) were sealed and held at 53° F. for 24 hours before being connected to normal storage ventilation.

In a first test the potatoes had white “peeps” showing from the eyes before treatment. When inspected about 24 hours after treatment these peeps were burned to a dark color and were inactivated without any damage to potato flesh adjacent the eyes.

In a second test the potatoes were treated with 1-nonanol at the same fogging temperature and dosage for the same period of time to achieve the same application dosage as in Example I. The potatoes in this storage had sprouts averaging in excess of about 2 cm in length. In this experiment, potatoes with very long sprouts, some up to eight cm or more, were treated with 1, 2, and 4 times sequentially with full strength nonanol. This was done because preliminary experiments showed that one application of nonanol was unable to kill such large sprouts. This “spray-paint” method was thus used to try to bring the total amount (rate) of nonanol up to a level capable of killing large sprouts as well as peeps, a necessity in commercial settings where sprouts of all sizes exist. It required 4 applications to reach the level at which these large sprouts were completely killed. The negative side effect observed was a wet, slimy, sprout rot, which dampened but did not otherwise rot the tuber skin or tissue that came in contact with these sprouts. While this was a small scale test, a whole storage full of potatoes in this condition would likely lead to secondary decays. Single or even double applications didn't reach a level of nonanol high enough to completely kill these large-sized sprouts.

At the applied dosage, 1-nonanol proved very effective in safely burning “peeps” on stored potatoes in the above-described tests. This is important for fresh-pack potatoes since packing houses prefer potatoes for the consumer market where no “white peeps” are evident. Commercially stored potatoes, however, which show “peeps” also frequently exhibit sprouts on potatoes in different parts of a large pile in a large storage facility. Thus, an effective treatment with a higher alcohol must be conducted so that peeps and sprouts are “burned” but without any damage to the flesh of the treated potatoes.

Although 1-nonanol has a detectable odor, it is not as objectionable nor as strong as that of clove oil, which has previously been used as a “burn” agent for potatoes with peeps or sprouts. In fact, packing houses for fresh-pack potatoes often decline to use clove oil treated potatoes because of its malodorous smell. A further advantage of nonanol is illustrated in Example III. Wherein a dosage of nonanol at about one-fourth the dosage of clove oil is equal in effectiveness. Thus, there is much less detectable odor with nonanol when achieving an equivalent “burn” to clove oil.

### EXAMPLE III

Treatment via fogging at an appropriate temperature at appropriate dosage for a short duration showed 1-nonanol to be about four times as effective as clove oil in “burning” peeps and sprouts when applied at similar dosages.

### EXAMPLE IV

Various sprout suppressing chemicals were compared for their ability to suppress existing sprouts on post-dormant potatoes with peeps and sprouts extant. All chemicals were applied via a thermofogging technique at comparable dosages and fogging chamber temperature sufficiently low to prevent combustion, but yielding a stable aerosol. The results are set forth in the following table.

| | Burn | Burn | | |
|---|---|---|---|---|
| Chemical | “old” | “new” | Smell | Comments |
| Clove oil | ++ | ++ | Strong clove | |
| 1-Nonanol | +++ | +++ | Moderate | |
| Oregano oil | ++ | ++ | Strong spice | |
| AmylAcetate | na | ++ | Rotten banana | |
| Hexanol | + | ++ | Pleasant, fruity | |
| Dodecanol | −\+ | − | moderate | Stringy, sticky liquid |
| | | | | residue on treated |
| | | | | potatoes |
| Dipropylene | −\+ | − | moderate | |
| Glycol | | | | |
| 1-Octanol | ++ | +++ | Pleasant, slight | |
| 1-Decanol | ++ | ++ | moderate | |

In the above table the explanation of the designation is as follows:
+ - indicates fair effectiveness
++ - indicates good effectiveness
+++ - indicates excellent effectiveness
A minus (−) sign indicates no noticeable effect while a +/− sign indicates only partial effectiveness at a minimal level.

A minus (−) sign indicates no noticeable effect while a +/− sign indicates only partial effectiveness at a minimal level.

Clove oil applied at a predetermined dosage gave a “burn” effectiveness of 46% of existing peeps while 1-nonanol at a dosage one-fourth as great gave a 50% “burn.” At a one-half dosage, 1-nonanol provided a 100% “burn” effectiveness within 24 hours after treatment.

In the above table “Burn old” refers to the effect upon old sprouts, which included sprouts up to nine months old, these being generally more difficult to desiccate, while “burn new” refers to newly emerged sprouts and peeps, generally less than a month or so in existence.

Clove oil contains active ingredients eugenol and isoeugenol; cyclical organic phenols. Oregano oil is composed of carvacol, thymol, limonene, pinene, ocimene and carophyllene. Eugenol, isoeugenol, carvacol and thymol, all phenol-type compounds, are also characterized as monoterpenes. These various chemicals have previously been used or tested as sprout inhibitors.

The chemicals which performed best in this test were 1-octanol and 1-nonanol. They most effectively desiccated existing peeps and sprouts and were noticeably better than clove oil, which has been used commercially for this purpose for about a decade. Also, 1-octanol and 1-nonanol had less objectionable odor than clove oil, with 1-octanol being preferred for its mild, pleasing fragrance and lower toxicity. Both 1-octanol and 1-nonanol achieved a better “burn” than clove oil even when applied at dosages of about one-half the clove oil dosage.

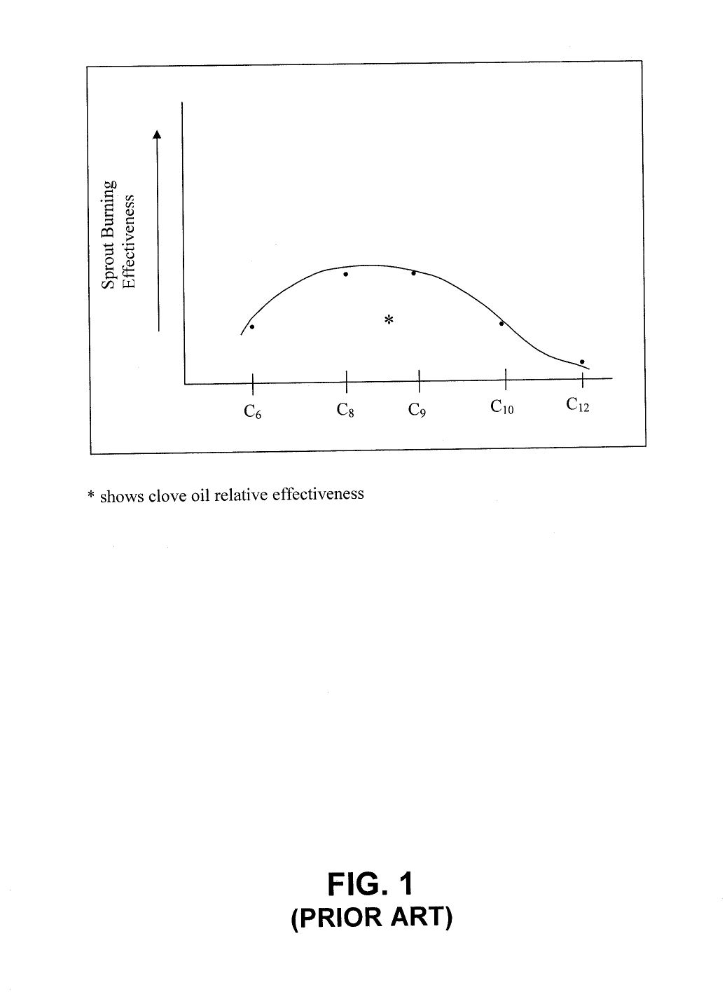

The effectiveness of the higher saturated alkyl alcohols followed a pattern as shown in the graph of FIG. 1.

The best results were achieved with C₈-C₁₀ alkanols, with 1-octanol and 1-nonanol being the most effective. Each of these was significantly better than clove oil which has been used extensively as a sprout suppressant agent for the past several years. Neither 1-octanol nor 1-nonanol have as strong and objectionable odor as clove oil even when used at an equivalent dosage. (See U.S. Pat. No. 6,723,364 Xeda International, also see U.S. Patent Publication 2009/0062126)

In the experiments conducted and reported herein, it was found that applying a higher alcohol via thermofogging for a short duration, e.g., usually less than about eight hours and preferably less than four hours to achieve a relatively high concentration of the alcohol in the headspace for a period of up to several days, was preferable and provided more effective results than wicking techniques. Generally, if the distribution of the alcohol vapor within a storage facility uniformly reaches all potatoes, the sprout burn effect is immediate and an exposure of 24 hours or less to the alcohol vapor is sufficient to give effective results.

### EXAMPLE V

An experiment was performed wherein 1-octanol at various dosages were applied to potatoes wherein the temperature of the potatoes was at about 36° F. The 1-octanol was applied via an electric thermofogger at a fog temperature within the fogger of about 500° F. to obtain a stable aerosol. The potatoes were examined about 24 hours after treatment. Evidence was apparent that the alcohol had condensed upon the skin of the potatoes, leaving large dark damaged spots.

The potatoes were cut open at the dark spots. Damage to the flesh of the potatoes existed to a depth of about 5 mm to 25 mm. Potato flesh was otherwise undamaged except under the dark spots. Potatoes which were held at 53° F. before being subjected to a similar dosage of 1-octanol at a similar fogging temperature and fogging rate did not show any evidence of condensation and did not show injury to the potato skin or to its flesh.

This experiment indicates that care must be observed even when treating with an aerosol of 1-octanol at a conventional dosage upon cold potatoes and that treatment of potatoes held at a temperature below about 40° F. may be counter indicated.

Given that other tests have established that octanol and nonanol, for example, are several times more effective at “burning” sprouts enables these alcohols to be applied at much lower dosages than, for example, clove oil, with great effectiveness and without damaging the potatoes. Also, given that potatoes are usually stored at temperatures above about 42° F. and that condensation of a higher alcohol upon the potatoes can generally be avoided by adjustment of dosage and aerosolization (fogging) temperatures. Fogging of chemicals at low fogging temperatures tends to give a wet fog, which in the case of higher alcohols could result in damage to treated potatoes.

This experiment, however, may confirm the concern expressed by Burton that large, concentrated dosages could be toxic to treated potatoes.

Fogging of higher alcohols in an admixture of water or under condition of high humidity may provide beneficial effects when a desired dosage of alcohol is applied to potatoes to “burn” peeps or sprouts and which may, perhaps, counter balance the strong desiccating effect of the higher alcohols on sprouts. Sprouts have more mass than peeps and may be more susceptible to transport of the higher alcohol into the potato flesh beneath or adjacent the base of the sprout. Although the reasons are not fully understood, the concurrent treatment of potatoes during storage or shipment with higher alcohols and may provide water desirable results.

While thermofogging of higher alcohols alone or in conjunction with diluents such as water and the like is particularly effective in treating potatoes in large storage facilities, the use of such alcohols alone or in the combinations set forth herein above as volatile agents during shipping of fresh-pack potatoes to market over a short time duration may also be very effective, provided that the dosage is controlled and loss temperatures, e.g., below about 42° F. are avoided.

In the above examples, the use of water as a diluent was advantageous in assisting the aerosolization of higher alcohols such as octanol and nonanol. However, these examples were based upon small quantitative volumes. Aerosolization of larger quantities in full scale aerosolization equipment permits successful fogging of a higher alcohol without dilution with water or any other diluent. Successful fogging is preferably conducted at or near the boiling point of the higher alcohol being fogged.

The preferred alcohols for the purposes of this invention besides n-nonanol are n-hexanol, n-octanol and n-decanol. Each of these provides a strong desiccating effect and their use upon potatoes having peeps or sprouts provide an effective “burn” effect. A further advantage of each of these is that each is considered safe for inclusion in foods. Generally, these alcohols are most effective when applied after peeps or sprouts are showing, in contrast to typical treatments with CIPC or 1,4 DMN.

Adjustment of dosage of each of the above-identified alcohols may be required to avoid pitting near the eyes of treated potatoes. Preferred treatments of potatoes with a higher alcohol alone may use a predetermined low dosage, e.g., as low as 10 ppm to about 25 ppm to avoid pitting. Diluents, such as water or other inert liquids may assist in controlling the desired dosage and/or any tendency to cause damage to the skin or flesh of the potato.

In the conducted experiments, 1-octanol appeared to provide excellent overall performance. (This is in contrast to results shown by Burton when C₁ to C₁₀ alcohols were compared.) It is effective to desiccate peeps, but also “kills” longer sprouts without the same tendency to damage flesh near the potato eye as observed with other chemicals. Further, the aroma of 1-octanol is pleasant and non-objectionable even over a wide range of dosages. It creates good, stable aerosols at temperatures of about 400° F. to about 500° F. Fogging by use of an electrically heated thermofogger rather than a combustion fogger provides excellent fogs with less likelihood of ignition of the octanol.

The treatment of stored potatoes having peeps or sprouts with a C₈ to C₁₀ alcohol as described hereinabove, may be particularly effective if the humidity of the storage facility is reduced to a low level before fogging is commenced. Some past experiments by Currah and Meigh, J. Sci. Fd. Agric. vol. 19, July (1968) p. 409 et seq., created an inference that water and nonanol, for example, competed with one another for uptake by potatoes. Current experimentation did not provide a conclusion re the effect upon sprout suppression when treatments were made at high or low humidity conditions so long as condensation was avoided.

Although fogging of the described alcohols, such as 1-octanol, is effective at both high and low humidity conditions, current experiments indicate that fogging of potatoes at a low humidity condition permits the use of a lower dosage over a short period of time without loss of effectiveness in killing peeps and sprouts.

A particularly effective use of the alcohols identified herein to desiccate substantially all sprouts existing on treated potatoes is to do so after a previous chemical treatment has been made to disrupt apical dominance so that substantially all eyes on the treated potatoes are peeping or sprouting to substantially the same extent.

Apical dominance may be disrupted by treating stored potatoes with one or more of the following chemicals: CIPC and/or 1,4 DMN at dosages typically used for sprout inhibition.

Once apical dominance is disrupted, the stored potatoes may thereafter be treated with a higher alcohol, such as 1-octanol or 1-nonanol of an appropriate dosage when peeps (nascent sprouts) first appear.

From the experiments conducted and described herein, it is deemed important to avoid condensation of higher alcohols, such as octanol or nonanol, upon stored potatoes. Introducing these higher alcohols via thermofoggers as aerosols at temperatures above the alcohol boiling point is significant in keeping the alcohol as a vapor in the headspace air. Also, treating the stored potatoes with a moderate dosage over a brief period of time enhances the opportunity for the alcohol vapor to be preferentially adsorbed by the exposed peep tissue which tends to be more receptive to the alcohol vapor than the potato skin. Venting of such air alcohol treated storage facility within 48 hours or even less, is further advantageous in avoiding a sufficient build-up of alcohol vapor in the headspace that the dew point concentration of the alcohol vapor at the headspace air temperature is exceeded.

1. A method of desiccating sprouts existing on post-harvest potatoes comprising:
thermofogging an alcohol selected from the group consisting of heptanol, octanol, nonanol, and decanol to create a stable aerosol of said alcohol;
introducing said aerosol into a mass of potatoes containing potatoes exhibiting sprouts for a predetermined period of time at a predetermined dosage to desiccate effectively such sprouts.

2. The method of claim 1, wherein said alcohol is introduced to said potatoes at a dosage sufficient to maintain said sprouts in a desiccated state for a period of at least four weeks.

3. The method of claim 2, wherein said dosage is predetermined to create a residue upon said treated potatoes of from about 10 ppm to about 50 ppm based upon the weight of said potatoes.

4. The method of claim 1, wherein said alcohols are thermofogged in a combustion-type thermofogger.

5. The method of claim 1, wherein said alcohols are thermofogged at a rate to complete a thermofogging treatment of a commercial potato storage in less than about six hours.

6. The method of claim 1, wherein said post-harvest potatoes contain a detectable residue of CIPC and/or 1,4 DMN.

7. The method of claim 1, wherein said alcohol is 1-octanol.

8. The method of claim 7, wherein said 1-octanol is thermofogged via an electrically heated thermofogged.

9. The method of claim 7, wherein said 1-octanol is thermofogged at a temperature of about 400° F. to about 600° F.

10. A method of desiccating sprouts on post-harvest potatoes comprising applying a thermofogged aerosol of a C₈-C₁₀ alkyl alcohol for a predetermined period of time to provide a concentration of said alcohol in the atmosphere surrounding said potatoes effective to desiccate sprouts and/or peeps present upon said potatoes.

11. The method of claim 10, wherein said thermofogged aerosol is produced in a hot gas stream at a temperature of less than about 600° F.

12. The method of claim 10, wherein said thermofogged aerosol is introduced to said potatoes over a time period of less than about six hours.

13. The method of claim 10, wherein said thermofogged aerosol provides said higher alcohol at a dosage of less than about 50 ppm based upon the total weight of said potatoes.

14. The process of claim 10, wherein said potatoes are in a storage facility and are exhibiting peeps and/or sprouts in a non-apical dominant state.

15. The method of claim 10, wherein said potatoes are in a nascent sprouting condition.

16. The method of claim 10, wherein said alcohol is thermofogged at a temperature approximating its boiling point.

17. The method of claim 15, wherein said alcohol is in a mixture with a diluent.

18. The method of claim 15, wherein said alcohol is 1-nonanol, 1-octanol, or 1-decanol.

19. The method of claim 1, wherein the temperature of the potatoes is above about 42° F.

20. The method of claim 10, wherein the temperature of the potatoes is above about 42° F.
